(19) United States
(12) Patent Application Publication
(10) Pub. No.: US 2004/0236862 A1
(43) Pub. Date: Nov. 25, 2004

(54) Image forming apparatus for distributing data and information processing apparatus for obtaining data from image forming apparatus

(76) Inventors: Tatsuo Ito, Kanagawa (JP); Sachiko Mihira, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/795,393

(22) Filed: Mar. 9, 2004

(30) Foreign Application Priority Data
Mar. 10, 2003 (JP) 2003-063976
Mar. 1, 2004 (JP) 2004-055693

(51) Int. Cl. G06F 15/16; H04N 1/00

(52) U.S. Cl. 709/230; 709/217; 358/400

(57) ABSTRACT

In an image forming apparatus, a plurality of communication ports sends and receives data in accordance with different communication protocols. A data managing part stores and manages the data received from the plurality of communication ports as a data file in a storing part. A data distributing part distributes the data file to a device in response to a request concerning obtaining the data file from the device connected to the image apparatus through a network.

### BACKGROUND OF THE INVENTION

1. Field of the Invention

The present invention generally relates to an image forming apparatus and an information processing apparatus, in which the image forming apparatus manages documents received from a plurality of ports having different communication protocols and sends the documents in response to a polling which is sent from the information processing apparatus to obtain the documents through a network.

2. Description of the Related Art

Conventionally, as shown in FIG. 1, a receiving/distributing server 902 has been provided to receive image data through a network from an image forming apparatus 901 having a fax receiving function and a networking function, and distribute the image data to a predetermined user PCs (Personal Computers) 904 by a push type communication method.

Since the image forming apparatus 901 knows a timing of receiving the document by fax, the image forming apparatus can send the image data of the document received by fax to the receiving/distributing server 902 immediately after the image forming apparatus 901 received the document by fax. The receiving/distributing server 902 stores the image data sent from the image forming apparatus 901 in a data accumulating HDD (Hard Disk) 903, and distributes the image data to the user PCs 904.

In a conventional system as described above, by providing the receiving/distributing server 902 that can conduct a distribution control to the user PCs 904, and structuring a network configuration as shown in FIG. 1, the user PCs 904, which do not have the fax function, can receive the document sent by fax.

However, in the conventional network configuration of the push type, the receiving/distributing server 902 is required. Accordingly, even a small size office is required to have a server having a high function and an extra workload is required to install the server to the existing network configuration and maintain the server.

Moreover, in the small size office, even if the image data (document) received by the fax function of the image forming apparatus 901 is accumulated in a memory, the image data (document) cannot be used directly as an electronic data. Accordingly, if the small size office does not have the image forming apparatus 901, the small size office is required to maintain document sheets where images are formed based on the image data and output from the image forming apparatus.

Furthermore, recently, since various office apparatuses have been widely spread, various image formations such as image data (document) sent by fax, copy, e-mail or a like through a network can be conducted. Accordingly., a user can obtain the image data (document) by various communication protocols. Conventionally, the image data is managed for each function of the image formations. Thus, when the user receives the same image data (document) by fax and email, a time difference is caused by a timing the user receives and then the use is confused to determine which image data is latest one.

### SUMMARY OF THE INVENTION

It is a general object of the present invention to provide document processing apparatuses in which the above-mentioned problems are eliminated.

A more specific object of the present invention is to provide an image forming apparatus which centralizes and manages documents received from a plurality of ports being different communication protocols and providing a Web service for sending the documents in response to a polling, which is conducted to obtain the documents, from an information processing apparatus connected through a network.

From a first aspect, the above objects of the present invention are achieved by an image forming apparatus, including: a plurality of communication ports sending and receiving data in accordance with different communication protocols; a data managing part storing and managing the data received from the plurality of communication ports as a data file in a storing part; a data distributing part distributing the data file to a device in response to a request concerning obtaining the data file from the device connected to the image apparatus through a network.

According to the present invention, in the image forming apparatus, without installing a receiving/distributing server to a network other than the image forming apparatus, it is possible for the image forming apparatus to directly provide a document (image data) indicated by a request from a device, to the device. Moreover, since the image forming apparatus centralizes image data receives from a plurality of ports, it is not required to mount the data managing part for each of various communication parts. Furthermore, the image data desired by the user from various image data centralized and managed in the image forming apparatus can be delivered to the device used by the user.

Moreover, from a second aspect, the image forming apparatus may includes a plurality of image processing parts conducting different image processes for data in accordance to different process types.

According to the present invention, in the image forming apparatus, for example, the image data generated by fax, plotter, scanner, or a like may be centralized and managed as the data file. Accordingly, the device used by the user is not required to connect to various image forming apparatuses and to manage the image data generated by the various image forming apparatuses.

Furthermore, from a third aspect, in the image forming apparatus, the data distributing part may include a file providing part providing the data file corresponding to file identification information indicated by an obtain request when the obtain request of the data file is received from the device.

According to the present invention, in the image forming apparatus, in response to a request from the device, the data file can be distributed.

Moreover, from a fourth aspect, in the image forming apparatus, the data distributing part further may include an extraction result providing part conducting a process in accordance with the communication port or the process type indicated by an extraction condition included in an extract request, and providing an extraction result to the device, when the extract request of the data file is received from the device. Furthermore, from a fifth aspect, in the image forming apparatus, the extraction result providing part may extract data related information concerning data of the data file from the storing part in accordance with the extraction condition.

According to the present invention, in the image processing apparatus, for example, only items can be extracted from the bibliographic information of the data file corresponding to the communication port or the process type of an extraction condition indicated by the device and can be provided as an extraction result to the device.

Moreover, from a sixth aspect, in the image forming apparatus, a file providing part includes: a first part checking a validity of the file identification information; a second part checking an access right to the data file identified by the file identification information; and a third part accessing the data file identified by the file identification information based on a check result by said second part.

Moreover, from a seventh aspect, the image forming apparatus may include a communication controlling part conducting a communication control in accordance with a predetermined Web communication protocol, wherein said data distributing part includes a description form processing part interpreting contents of the request in accordance with a predetermined description form and creating a process result corresponding the request in accordance with the predetermined description form. Furthermore, from an eighth aspect, in the image forming apparatus, the data distributing part may include a message exchange processing part processing the request received by said communication controlling part in accordance with a predetermined message exchanging protocol, so that the request is informed to said description form processing part, and creating a response based on the process result, which is created by said description form processing part, in accordance with the message exchange protocol, so that the response is sent to the device by the communication controlling part.

According to the present invention, in the image forming apparatus, since a communication with the device can be conducted in accordance with the HTTP, it is possible to receive a polling by an HTTP request and provide image data indicated in the HTTP response. Furthermore, it is possible to describe a message in the XML in accordance with a SOAP in bodies of the HTTP request and the HTTP response. The image forming apparatus can be realize to provide information as a Web service in response to the polling from the device.

The above objects of the present invention can be achieved by a program for causing a computer functioning as an information processing apparatus to obtain a data file from a server computer capable of accumulating the data file through a network or by a computer-readable recording medium recorded with the program.

### BRIEF DESCRIPTION OF THE DRAWINGS

In the following, embodiments of the present invention will be described with reference to the accompanying drawings.

FIG. 1 is a block diagram showing a conventional network configuration for distributing image data by a push type;

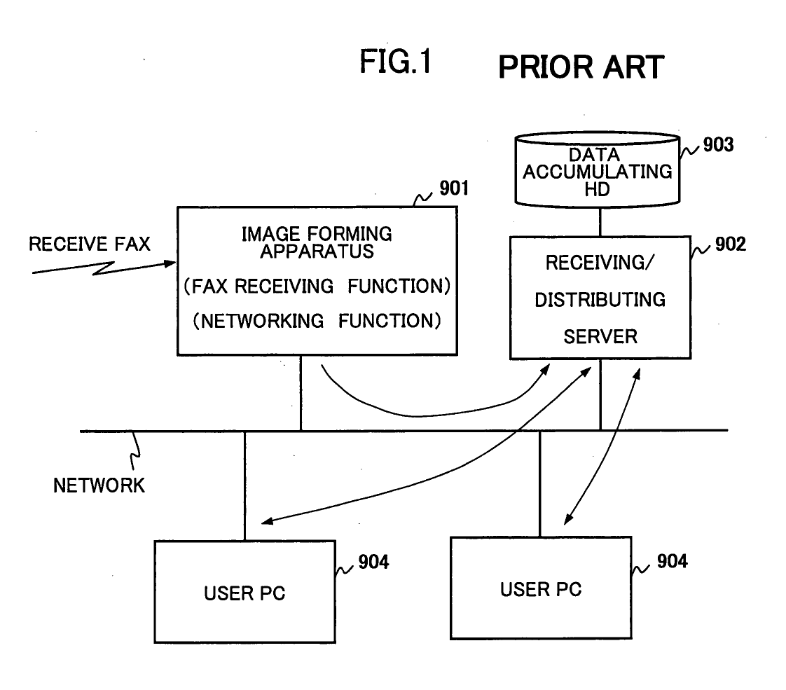

FIG. 2 is a diagram showing a network configuration for distributing image data in a pull type according to an embodiment of the present invention;

FIG. 3 is a block diagram showing the functional configuration of the multi-functional apparatus including the various image forming functions according to the embodiment of the present invention;

FIG. 4 is a block diagram showing a hardware configuration of the multi-functional apparatus shown in FIG. 3;

FIG. 5 is a diagram showing a first functional configuration of the multi-functional apparatus that provides the Web service, according to the embodiment of the present invention;

FIG. 6 is a diagram showing a second functional configuration of the multi-functional apparatus providing the Web service according to the embodiment of the present invention;

FIG. 7 is a flowchart for explaining a fax receiving process according to the embodiment of the present invention;

FIG. 8A is a diagram showing a configuration of the bibliographic information for received fax, according to the embodiment of the present invention and FIG. 8B is a diagram showing a configuration of the bibliographic information for a copy repository, according to the embodiment of the present invention;

FIG. 9 is a flowchart for explaining a polling process conducted from the user PC to the multi-functional apparatus according to the embodiment of the present invention;

FIG. 10 is a flowchart for briefly explaining a Web service providing process conducted by the multi-functional apparatus according to the embodiment of the present invention;

FIG. 11 is a flowchart for explaining the system information providing process conducted by the multi-functional apparatus according to the embodiment of the present invention;

FIG. 12 is a flowchart for explaining a first process for a case in that a sorting method is the received date and time, according to the embodiment of the present invention;

FIG. 13 is a flowchart for explaining a second process for a case in that the sorting method is the accumulated date and time, according to the embodiment of the present invention;

FIG. 14 is a flowchart for explaining a third process for a case in that the sorting method is the document ID, according to the embodiment of the present invention;

FIG. 15 is a diagram showing an access right table showing an access right set for each port, according to the embodiment of the present invention;

FIG. 16 is a flowchart for explaining the document writing out process conducted by the multi-functional apparatus 1200 according to the embodiment of the present invention;

FIG. 17 is a flowchart for explaining the document deleting process conducted by the multi-functional apparatus according to the embodiment of the present invention;

FIG. 18 is a diagram showing an HTTP request indicating the extraction condition and the sorting method sent from the user PC, according to the embodiment of the present invention;

FIG. 19 is a diagram showing the HTTP request indicating the extraction condition and the sorting method sent from the user PC, according to the embodiment of the present invention;

FIG. 20 is a diagram showing an HTTP response showing a sort result sent by the multi-functional apparatus according to the embodiment of the present invention;

FIG. 21 is a diagram showing the HTTP response showing a sort result sent by the multi-functional apparatus according to the embodiment of the present invention; and

FIG. 22 is a block diagram showing the hardware configuration of the user PC according to the embodiment of the present invention.

### DESCRIPTION OF THE PREFERRED EMBODIMENT

In the following, an embodiment of the present invention according will be described with reference to the accompanying drawings.

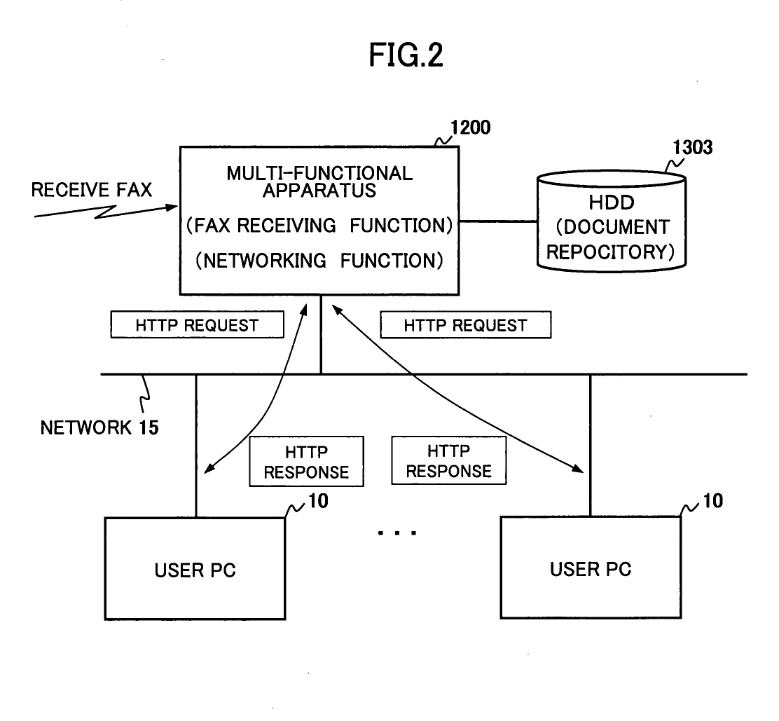

FIG. 2 is a diagram showing a network configuration for distributing image data in a pull type according to an embodiment of the present invention. In FIG. 2, an image forming apparatus (hereinafter, called a multi-functional apparatus) 1200 realizing various image forming functions in a single body includes at least a fax receiving function and a networking function, and is connected to a plurality of user PCs 10 through a network 15. The multi-functional apparatus 1200 accumulates documents received by the fax receiving function to an HDD 1303 and manages the documents in the HDD 1303.

The multi-functional apparatus and each of the user PCs 10 are capable of communicating each other in accordance with an HTTP (Hypertext Transfer Protocol). The user PCs 10 sends an HTTP request showing a request (for obtaining a document ID list or document data) concerning the document data which are received and managed by the multi-functional apparatus 1200), and responds by a process result as an HTPP response to the HTTP request.

The image forming apparatus 1200 receives the HTTP request from the user PCs 10, conducts a process corresponding to the HTTP request, and provides the process result or information in response to the HTTP request as a Web service.

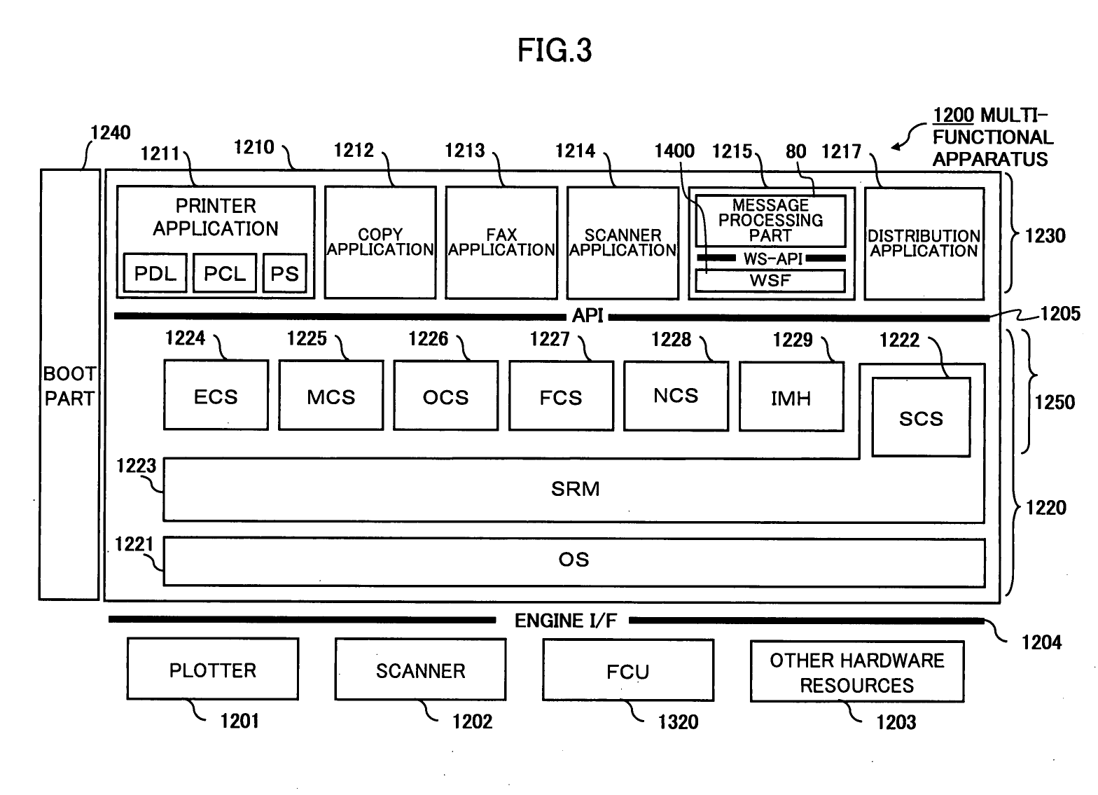

For example, a functional configuration of the multi-functional apparatus including various image forming functions according to the present invention is shown in FIG. 3. FIG. 3 is a block diagram showing the functional configuration of the multi-functional apparatus including the various image forming functions according to the embodiment of the present invention.

In FIG. 3, the multi-functional apparatus 1200 includes a plotter 1201, a scanner 1202, an FCU (Fax Control Unit) 1320, and other hardware resources 1203, and includes a software group 1210 including a platform 1220 and an application 1230, and a boot part 1240.

The boot part 1240 activates the platform 1220 and the application 1230 when the multi-functional apparatus 1200 is turned on.

The platform 1220 includes a control service 1250, an SRM (system resource manager) 1223 for managing one or a plurality of hardware resources and mediating an acquisition request from the control service 1250, and an OS (Operating System) 1221.

The control service 1250 interprets a process request from the application 1230 and issues an acquisition request of the hardware resource. The control service 1250 includes an SCS (System Control Service) 1222, an ECS (Engine Control Service) 1224, an MCS (Memory Control Service) 1225, an OCS (Operation panel Control Service) 1226, an FCS (Fax Control Service) 1227, an NCS (Network Control Service) 1228, and an IMH (Image Memory Handler) 1229. The platform 1220 includes an API (Application Program Interface) 1205 which can receive the process request from the application by predefined functions.

The OS 1221 is an operating system such as UNIXT™, and executes each of software of the platform 1220 and the application 1230 in parallel.

The SRM 1223 controls a system and manages resources with the SCS 1222.

The SCS 1222 conducts a plurality of functions such as an application management, an operation panel control, a system screen display (a job list screen, a counter display screen, and a like), an LED display, a resource management, an interruption application control, and alike.

The ECS 1224 controls engine parts such as the FCU 1320, the plotter 1201, the scanner 1202, and other hardware resources 1203 through an engine I/F 1204.

The MCS 1225 conducts a memory control.

The OCS 1226 controls an operation panel being an information communicating part between an operator and the multi-functional apparatus.

The FCS 1227 conducts a facsimile transmission, a registration/inquirer of various facsimile data, a facsimile read, a facsimile receive and print, and a synthesized sending and receiving.

The NCS 1228 is a module group for providing service utilized in common by applications needing a network I/O, distributes data received by each protocol from the network to the applications, and mediates data from the applications to send to the network.

For example, the NCS 1228 controls a data communication with a network device such as the user PCx 10 connected through the Internet by an httpd (Hypertext Transfer Protocol Daemon) 2 which one of the plurality of protocols, executes a plurality of Web services necessary for a process indicated in an HTTP request header by functions, and informs the process result by the plurality of Web services to the network device by an HTTP response. For example, the Web service is conducted in accordance with a message described in an XML (extensible Markup Language).

The IMH 1229 maps image data from a vertical memory area (user vertical space) to a physical memory.

The application 1230 includes a plurality of applications: a printer applications 1211 for a printer having a Page Description Language (PDL), PCL and Post Script (PS), a copy application 1212 for a copier, an FAX application 1213 for a facsimile, a scanner application 1214 for a scanner, a Web service process application 1215 for processing a service, a distributing application 1217 for delivering information.

Each of the applications 1211 through 1217 is executed by utilizing each process on the platform 1220.

The Web service process application 1215 includes a message processing part 80 for conducting a message exchange in accordance with an SOP (Simple Object Access Protocol) or a predetermined description format, and at least one Web service function (WSF) 1400 for conducting a predetermined process by utilizing the control service 1250 via the API 1205 and for providing the service via a WS-API (Web Service Application Program Interface).

As described above, the multi-functional apparatus 1200 centralizes and manages processes necessary in common by the applications 1211 through 1217.

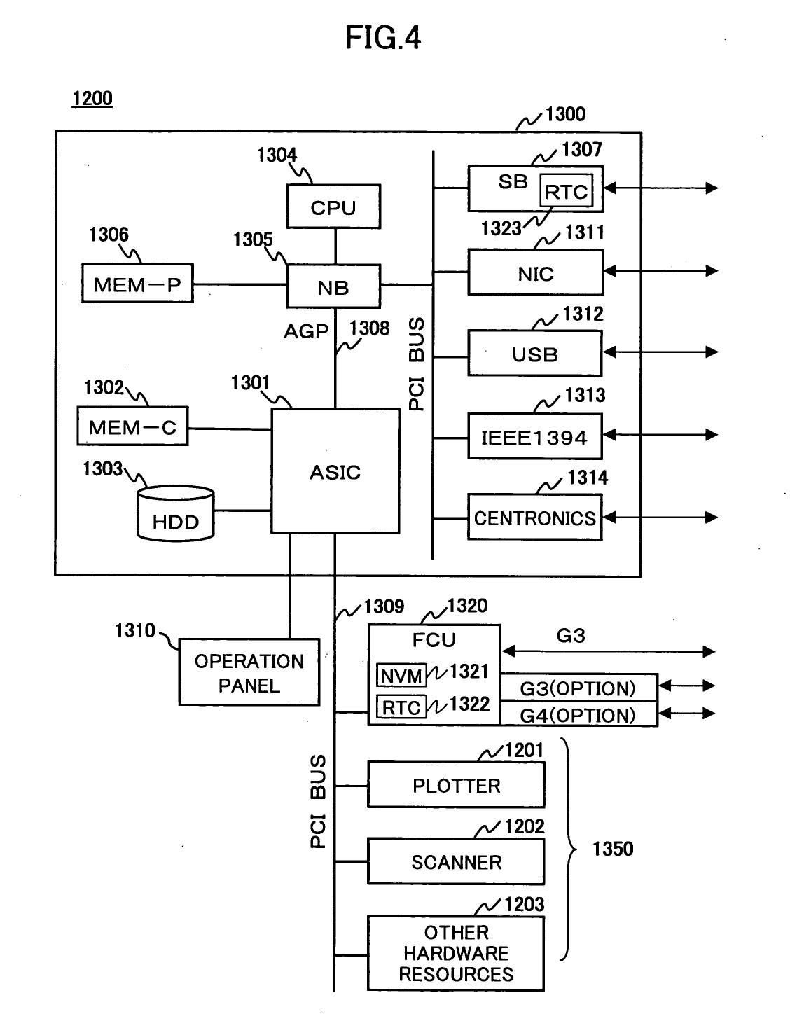

Next, a hardware configuration of the multi-functional apparatus 1200 will be described with reference to FIG. 4. FIG. 4 is a block diagram showing the hardware configuration of the multi-functional apparatus in FIG. 3 according to the embodiment of the present invention. As shown in FIG. 4, in the multi-functional apparatus 1200, an operation panel 1310, a FAX control unit (FCU) 1320, an engine part 1350 including the plotter 1201, the scanner 1202, and other hardware resources 1203, and an ASIC 1301 of a controller 1300 are connected via a PCI (Peripheral Component Interconnect) bus 1309 and a like. The FCU 1320 includes a non-volatile memory (NVM) 1321 for storing fax data received by fas and a RTC (Real Time Clock) 1322 for clocking time in the FCU 1320, and generally sends or receives the fax data in accordance with a G3 standard. The FCU 1320 may optionally include another G3 standard port and a G4 standard port.

In the controller 1300, the ASIC 1301 is connected to an MEM-C 1302 and the HDD (Hard Disk Drive) 1303 and the ASIC 1301 is also connected to a CPU 1304 via an NB 1305 of a CPU chipset, since an interface of the CPU 1304 has not been published.

It should be noted that the ASIC 1301 is connected to the NB 1305 via an AGP (Accelerated Graphics Port) 1308, instead of simply connecting via the PCI bus 1309. Because a connection via the PCI bus 1309, which is slower, ends up to too low performance to execute and control a plurality of processes forming the platform 1220 and the application 1230.

The CPU 1304 controls the entire Multi-functional business apparatus 1200. In detail, the CPU 1304 activates and executes the SCS 1222, the SRM 1223, the ECS 1224, the MCS 1225, the OCS 1226, the FCS 1227, the NCS 1228, and the IMH 1229, all of which form the platform 1220 on the OS 1221, as processes, respectively. Also, the CPU 1304 activates and executes the printer application 1211, the copy application 1212, the FAX application 1213, the scanner application 1214, the Web service process application 1215, and the distributing application 1217.

The NB 1305 serves as a bridge to connect the CPU 1304 with an MEM-P 1306, an SB 1307, and the ASIC 1301, respectively. The MEM-P 1306 is a system memory used as a drawing memory of the Multi-functional business apparatus 1200. The MEM-C 1302 serves as a local memory used as an image buffer for a copy and a coding buffer. The ASIC 1301 is an IC (Integrated Circuit) used for the image process including hardware elements.

NB 1305 connects with the SB 1307 through the PCI bus 1319. Also, NB 1305 connects with NIC 1311 (Network Interface Card) for controlling network communication, a USB (Universal Serial Bus) target 1312 capable of receiving data as a USB disk, an IEEE1394 1313 to be connected by a dedicate cable for IEEE1394, a centronics 1314 to be connected by a parallel cable, a serial port 1315 to be connected by a serial cable, a USB host 1316 capable of sending and receiving a large amount of image data by connecting with another USB target (for example, a personal computer).

The SB 1307 is a bridge to connect the NB 1305 with a ROM (Read Only Memory), a PCI device, and a peripheral device. SB 1307 includes an RTC (Real Time Clock) 1323 which measures a time in the controller 1300. Moreover, SB 1307 includes a USB host inside. For example, SB 1307 can receive image data by connecting a camera that supports a USB connection. Moreover, SB 1307 can also receive data from other USB targets.

In the multi-functional business apparatus 1200, data are sent and received through a plurality of ports: the SB 1307, the NIC 1311, the USB target 1312, the IEEE1394 1313, and the centronics 1314, the serial port 1315, the USB host 1316, the G3 standard, the G3 option, and G4 option of the FCU 1320. Then, the data are centralized and are managed in the HDD 1303.

The HDD 1303 is storage to store image data, programs, font data, forms, and a like. The operation panel 1310 is an operation part to receive an input operation from the operator and display information for the operator.

Therefore, in the ASIC 1301, a RAM interface to connect to the MEM-C 1302 and a hardware interface to connect to the HDD 1303 are provided. When the image data is input or output to or from the MEM-C 1302 or the HDD 1303, the ASIC 1301 switches to the RAM interface or the hardware interface.

The AGP 1308 is a bus interface for a graphic accelerator card, which is provided to improve a speed of a graphic process. The AGP 1308 can realize improved speed of the graphic accelerator card by directly accessing the system memory by a higher throughput.

In the following, a functional configuration for the multi-functional apparatus to provide the Web service will be described, in that the multi-functional apparatus 1200 includes the functional configuration shown in FIG. 3 and the hardware configuration shown in FIG. 4 as described above. The Web service is to receive the HTTP request indicating a service request from each of the user PC 10, to conduct a predetermined process corresponding to the service request, and to provide the process result by the HTTP response by the multi-functional apparatus 1200.

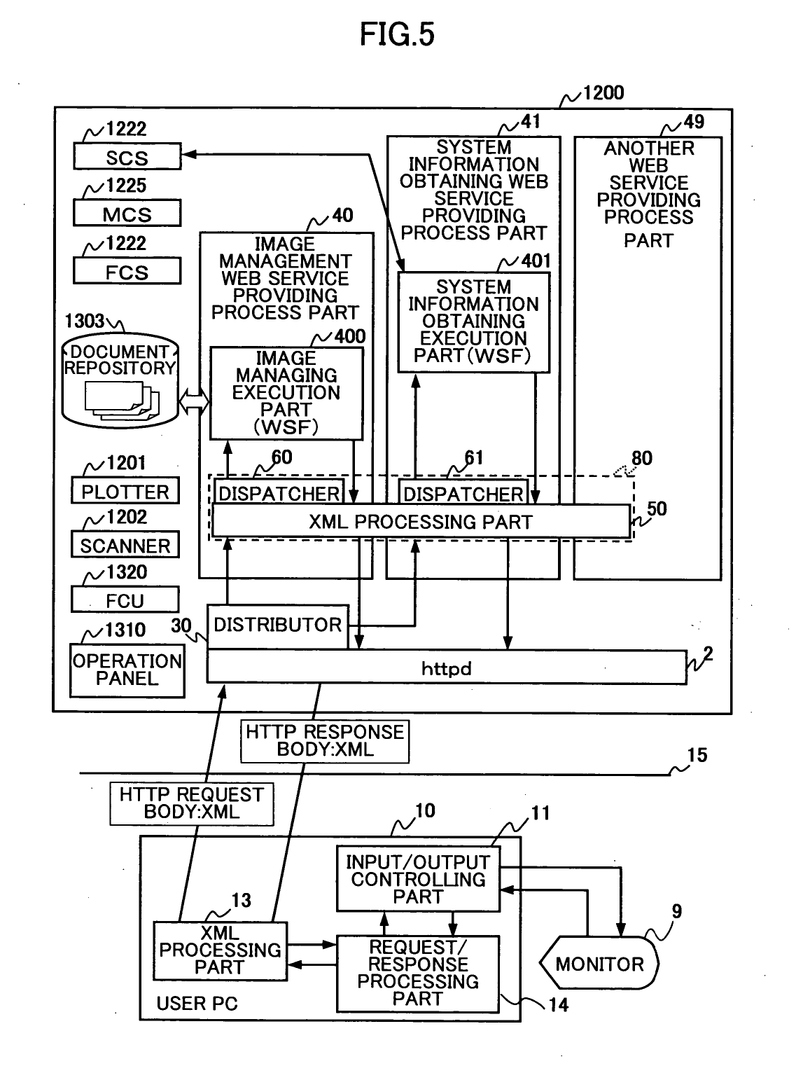

In the following, the functional configuration of the multi-functional apparatus 1200 capable of providing the Web service will be described with FIG. 5. FIG. 5 is a diagram showing a first functional configuration of the multi-functional apparatus that provides the Web service, according to the embodiment of the present invention. In FIG. 5, only main functional elements in the functional configuration of the multi-functional apparatus 1200 shown in FIG. 3 are shown, and other functional elements, which are not necessary for this explanation, are not shown and the explanation will be omitted. The multi-functional apparatus 1200 connects to the user PCs 10 receiving the Web service through the network 15.

In FIG. 5, the multi-functional apparatus 1200 includes a httpd 2 for conducting a communication control in accordance with the HTTP, a distributor 30 for distributing a process to a Web service providing process part corresponding to the HTTP request, a message providing process part 80 for processing a message by interpreting and generating the XML, an image management Web service providing process part 40, a system information obtaining Web service providing process part 41, and another Web service providing process part 49 as a plurality of Web service providing process part, the SCS 1222, the MCU 1225, the FCS 1227, the FCU 1320, the plotter 1201, the scanner 1202, the HDD 1303, the operation panel 1310, and the like.

The message processing part 80 includes an XML processing part 50 which is shared with the plurality of Web service providing process parts 40, 41, and 49, dispatchers 60, 61, . . . for dispatching a process to relative Web service providing process parts 40, 41, . . . based on a message showing process contents of the Web service analyzed by the XML processing part 50. It should be noted that the multi-functional apparatus 1200 can further include a plurality of Web service processing process parts.

The image management Web service providing process part 40 analyzes a message of the HTTP request concerning an image, makes an image managing execution part 400 conduct a process in accordance with the message, and generates a message showing a process result by the image managing execution part 400 to set in the HTTP response. The image managing execution part 400 is one of Web service functions (WSF) 1400, each of which executes the process indicated in the HTTP request being distributed by the dispatcher 60 by accessing the HDD 1303 where documents (image data) are accumulated, and response by sending the process result.

The HDD 1303 is an auxiliary storage unit for storing documents, and stores various image data generated by the FCU 1320, the plotter 1202, and the scanner 1202 as documents. Each of the user PCs 10 connected through the network 15 can retrieve a document (image data) stored in the HDD 1303 by utilizing the Web service provided by the multi-functional apparatus, as if each of the user PCs 10 retrieves the documents (image data) from their own hard disks.

The system information obtaining Web service providing process part 40 analyses a message of the HTTP request concerning the multi-functional apparatus 1200, makes a system information obtaining execution part 401 conduct a process in accordance with the message, and generates a message showing a process result by the system information obtaining executing part 401 to set in the HTTP response. The system information obtaining execution part 401 is one of Web service function (WSF) 1400 that executes the process indicated by the HTTP request distributed by the dispatcher 61, and responds by sending the process result.

Each of the user PCs 10 connected to the multi-functional apparatus 1200 through the network 15 includes an input/output controlling part 11 for controlling input data from an input unit such as a keyboard, a mouse, or a like and controlling output data to display at a monitor 9, an XML processing part 13 for processing process contents of the Web service with respect to the multi-functional apparatus 1200 and a process result of the Web service from the multi-functional apparatus 1200 by the XML, and a request/response processing part 14 for generating a request and analyzing a response in accordance with the HTTP.

The HTTP request is conducted to request the Web service by the data communication in accordance with the HTTP, and the HTTP response is conducted to respond by the process result of the Web service. In this first functional configuration in FIG. 5, bodies of the HTTP request and the HTTP response are described in the XML.

A user using the user PC 10 requests a Web service to the multi-functional apparatus 1200 at a screen for requesting the Web service to the multi-functional apparatus 1200 (step S1). In response to the request of the Web service from the user, the input/output controlling part 11 sends request data to the request/response processing part 14 (step S2). The request/response processing part 14 generates the HTTP request based on the request data received from the input/output controlling part 11 (step S3) and the XML processing part 13 writes process contents in a body of the HTTP request in the XML. Then, the HTTP request is sent to the multi-functional apparatus 1200 through the network 15 (step S4).

When the multi-functional apparatus 1200 receives the HTTP request by the httpd 2, the HTTP request is distributed to one of the Web service providing process part 40, 41, and 49 indicated in a head of the HTTP request by the distributor 30 (step S5). For example, when the image management Web service providing process part 40 is indicated, the image management Web service providing process part 40 is called by the distributor 30 (a predetermined function call).

In the image management Web service providing process part 40, the XML processing part 50 obtains the process contents from the body, which are written in the XML, of the HTTP request (step S6), and the process contents obtained by the XML processing part 50 is passed to the dispatcher 60 (step S7). The dispatcher 60 dispatches (passes) a process to be conducted by the Web service, to the image management Web service execution part 400 in accordance with the process contents (step S8). The image management Web service execution part 400 executes the process with respect to the HDD 1303 in accordance with the process contents and obtains the process result (step S9). For example, the image management Web service execution part 400 executes processes for obtaining the document ID, a document (image data), and a like indicated by the process contents.

The image management Web service execution part 400 sends the process result to the XML processing part 50 (step S10). The XML processing part 50 generates the body of the HTTP response in which the process result is written in the XML (step S11). Then, the XML processing part 50 sends the HTTP response which body includes the process result written in the XML, to the user PC 10 through the httpd 2.

When the user PC 10 receives the HTTP response, the XML processing part 13 analyses the body of the hTTP response and obtains the process result (step S13), and the request/response processing part 14 passes the process result as output data to the input/output controlling part 11 to display the process result at the monitor 9 (step S14). Then, the input/output controlling part 11 controls the output data to display at the monitor 9 (step S15).

Alternatively, the user PC 10 may schedules to automatically inquire the Web service of the multi-functional apparatus 1200, so that the steps S1 and S15 can be omitted. When the output data include image data, the PC 10 accumulates the image data in a predetermined storage area. The image data may be displayed at the monitor 9 if the user needs.

In a case in that the user PC 10 receives the Web service from the system information obtaining Web service providing process part 41 of the multi-functional apparatus 1200, the same process as described above can be conducted. When the system information obtaining Web service providing process part 41 receives the HTTP request, system information of the multi-functional apparatus 1200 is obtained from the SCS 1222 by the system information obtaining execution part 401 and the result is sent to the user PC 10 by the HTTP response.

Alternatively, the image management Web service providing process part 40 can conduct an internal process in the multi-functional apparatus 1200. For example, when the image management Web service providing process part 40 receives information showing that a fax is received, from the MCS 1225, the image management Web service providing process 40 can make the image managing execution part 400 managed bibliographic information of the image data received by fax.

In the first functional configuration as described above, the user PC 10 writes the process contents to the body of the HTTP request in accordance with a predetermined description format of the XML, so that the user PC 10 can obtain the document ID of the image data generated by the FCU 1320, the plotter 1201, or the scanner 1202 managed in the multi-functional apparatus 1200 and obtain the image data desired by the user by indicating the document ID obtained from the multi-functional apparatus 1200.

Also, the multi-functional apparatus 1200 can provides the document ID of the image data or the image data desired by the user as the Web service to the user PC 10 by writing the process result in the body of the HTTP response in accordance with the predetermined description format of the XML. As described above, the multi-functional apparatus 1200 can provides the Web service concerning the image data to the plurality of the user PC 10 through the network 15.

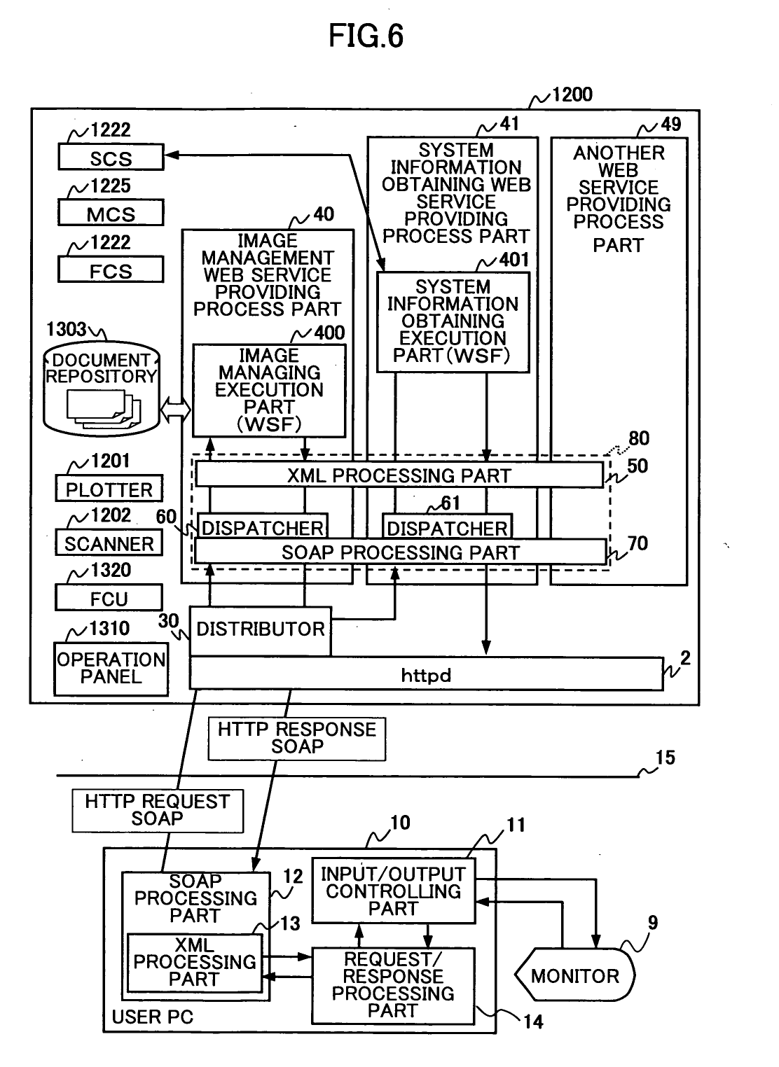

Next, another functional configuration of the multi-functional apparatus 1200 capable of providing the Web service in accordance with the SOAP will be described with reference to FIG. 6. FIG. 6 is a diagram showing a second functional configuration of the multi-functional apparatus providing the Web service according to the embodiment of the present invention. In FIG. 6, the same configuration elements that are the same ones in FIG. 5 are indicated by the same numerals and the explanation thereof will be omitted. The process flow is the same as one in FIG. 5 and the explanation thereof will be omitted.

In the second functional configuration shown in FIG. 6, the message processing part 80 includes a SOAP processing part 70 for controlling a message exchange in accordance with the SOAP in common by the plurality of the Web service providing process parts 40, 41, and 49 in the multi-functional apparatus 1200. Different from the first functional configuration as described above, the XML processing part 50 and the dispatcher 60 are included in the SOAP processing part 70. Moreover, the user PC 10 includes a SOAP processing part 12 for conducting the message exchange with the multi-functional apparatus 1200 in accordance with the SOAP. Different from the first functional configuration as described above, the XML processing part 13 for processing a message written in the XML is included in the SOAP processing part 12.

In the multi-functional apparatus 1200, the SOAP processing part 70 analyzes the header of the HTTP request, dispatches the process by the dispatcher 60, and obtains the process contents from the message written in the XML in the body of the HTTP request by the XML processing part 50. For example, the dispatcher 60 passes (dispatches) the process concerning the Web service to one of the image managing execution part 400 and the system information obtaining execution part 401. After that, for example, the SOAP processing part 70 receives the process result from the image managing execution part 400, writes the process result in the XML to the body of the HTTP response by the XML processing part 50, and sends the HTTP response to the user PC 10 in accordance with the SOAP.

In the second functional configuration, the dispatcher 60 is included in the XML processing part 50.

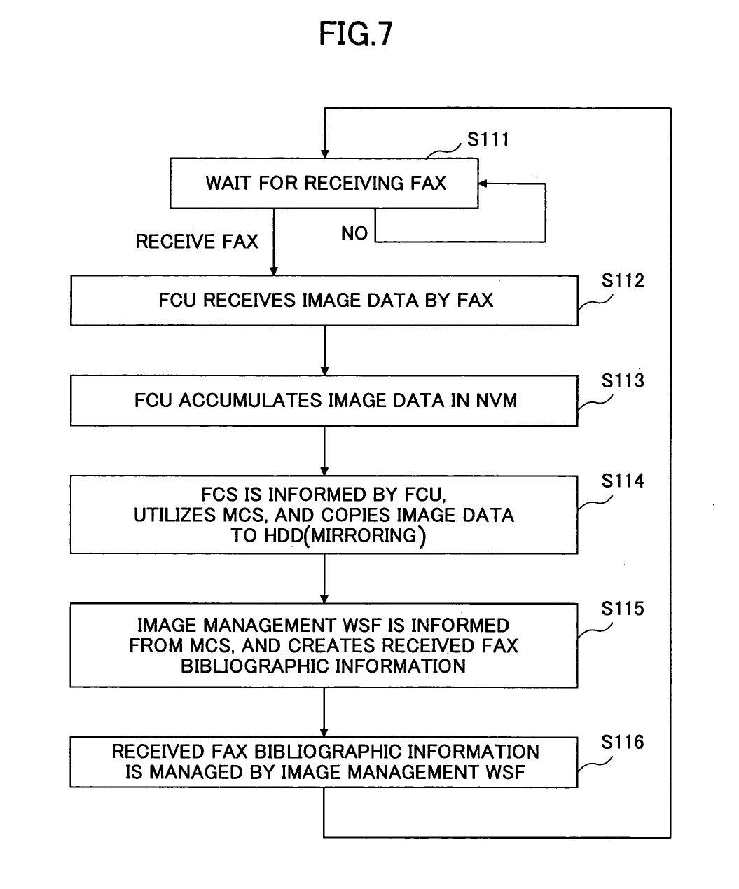

In FIG. 5 and FIG. 6, the process flow, in which the user PC 10 receives the image data accumulated in the multi-functional apparatus 1200 as the Web service from the multi-functional apparatus 1200, is described. Next, a process flow, in which the FCU 1320 receives the image data by fax and stores the image data in the HDD 1303 and the image managing execution part 400 manages bibliographic information, will be described with reference to FIG. 7.

FIG. 7 is a flowchart for explaining a fax receiving process according to the embodiment of the present invention. In FIG. 7, when the FCU 1320 receives a fax in a fax receive waiting state (step S111), the FCU 1320 starts to receive a fax and receives the image data (step S112). On the other hand, when no fax is received, the fax receive waiting sate is maintained. The FCU 1320 accumulates the image data received by fax in a non-volatile memory (NVM) 1321 (step S113).

The FCS 1227 receives information showing a fax receive from the FCS 1320, utilizes the MCS 1225, and copies the image data HDD 1303 (step S114). By copying the image data to the HDD 1303, the multi-functional apparatus 1200 can have a mirroring function which is effective when a problem occurs.

When the image managing execution part 400 receives the information showing the fax receive from the MCS 1225, the image managing execution part 400 creates the bibliographic information concerning the image data received by fax (step S115). The image managing execution part 400 manages the bibliographic information (step S116), and the fax receiving process goes back to the step S111 to wait for the fax receive.

As described above, in the step S114, by copying the image data received by fax to the HDD 1303, the multi-functional apparatus 1200 can have the mirroring function for an occurrence of a problem. Since the NVM 1321 of the FCU 1320 is a memory to receive a fax, the NVM 1321 is relatively small. Thus, the NVM 1321 can not conduct a document management to manage the image data received by fax. Accordingly, by copying the image data received by fax to the HDD 1303, the image data can be managed as same as other documents. Moreover, similarly, by copying the image data generated by the plotter 1201 and the scanner 1202 to the HDD 1303, it is possible to centralize and manage various image data generated various means in the HDD 1303.

Information concerning image data centralized and managed in the HDD 1303 is processed by the image managing execution part 400 to be easily utilized through the network 15. For example, indexes may be additionally provided to easily retrieve, the image data may be processed as image data read by an OCR (Optical Character Reader), or an image conversion may be conducted by corresponding to various purposes.

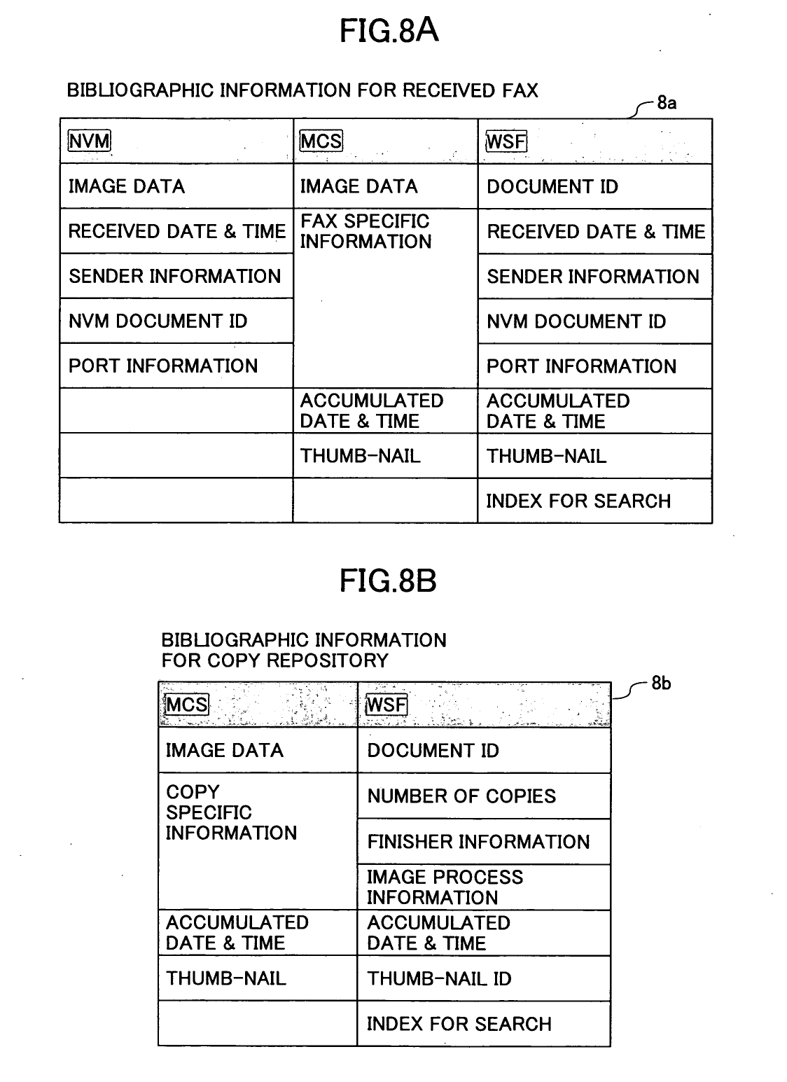

A configuration of the bibliographic information of the image data managed in the process as described in FIG. 7 will be described with reference to FIG. 8A and FIG. 8B. FIG. 8A is a diagram showing a configuration of the bibliographic information for received fax, according to the embodiment of the present invention.

In FIG. 8A, each of the NVM 1321 of the FCU 1320, the MCS 1225, and the image managing execution part 400 manages the bibliographic information for received fax. The bibliographic information managed by the NVM 1321 includes items of “RECEIVED DATE AND TIME” by an RTC (Real Time Clock) 1322 of the FCU 1320, “SENDER INFORMAITON” (for example, a telephone number or a like of the sender), “NVM document ID” for identifying the image data in the NVM 1321, “PORT INFORMATION” concerning a port available for the VCU 1320, and a like.

The bibliographic information managed by the MCS 1225 includes items of “IMAGE DATA” received externally, “FAX SPECIFIC INFORMATION” including information managed in the NVM 1321, “ACCUMULATED DATE AND TIME” by an RTC (Real Time Clock) 1323 of the SB 1307 when the MCS 1225 accumulates the image data, “THUMB-NAIL” for displaying at the operation panel 1310, and a like. The bibliographic information managed by the MCS 1225 is referred when necessary information is displayed at the operation panel 1310. An area for storing the fax specific information is an area to store printer specific information or copy specific information when the image data are generated by the plotter 1201 or the scanner 1202.

The bibliographic information managed by image managing execution part 400 includes items of “DOCUMENT ID” for specifying a document (image data), “RECEIVED DATE AND TIME” when the document (image data) received by fax, “SENDER INFORMATION”, “NVM DOCUMENT ID”, “PORT INFORMATION”, “ACCUMULATED DATE AND TIME” by the RTC 1323 of the SB 1307 when the image managing execution part 400 accumulated the bibliographic information, “THUMB-NAIL ID” for specifying a thumb-nail, “INDEX” for a search, and a like. “RECEIVED DATE AND TIME”, “SENDER INFORMATION”, “NVM DOCUMENT ID”, and “PORT INFORMATION” are information retrieved from the fax specific information of the MCS 1225. “DOCUMENT ID” shows a pointer showing a location where the image data managed by the MCS 1225 are stored. Accordingly, it is not required to manage the same image data redundantly and it is possible to effectively use a storage area for the image data. Also, “THUMB-NAIL ID” shows a pointer showing a location where a thumb-nail managed by the MCS 1225 is stored. The bibliographic information managed by the image managing execution part 400 is referred in order to provide the Web service through the network 15.

As described above, when the multi-functional apparatus 1200 receives the image data by fax, the bibliographic information is managed by the NCM 1321, the MCS 1225, and the image managing execution part 400.

FIG. 8B is a diagram showing a configuration of the bibliographic information for a copy repository, according to the embodiment of the present invention. In FIG. 8B, each of the MCS 1225 and the image managing execution part 400 manages the bibliographic information for the copy repository.

The bibliographic information managed by the MCS 1225 includes items of “IMAGE DATA” generated by the scanner 1202, “COPY SPECIFIC INFORMATION” informed by the scanner 1202, “ACCUMULATED DATE AND TIME” by the RTC 1323 of the SB 1307 when the MCS 1225 accumulated the bibliographic information, “THUMB-NAIL” for displaying at the operation panel 1310, and a like. The bibliographic information managed by the MCS 1225 is referred when necessary information is displayed at the operation panel 1310.

The bibliographic information managed by the image managing execution part 400 includes items of “DOCUMENT ID” for specifying a document (image data), “NUMBER OF COPIES”, “FINISHER INFORMATION”, “IMAGE PROCESS INFORMATION”, “ACCUMULATED DATE AND TIME” by the RTC 1323 of the SB 1307 when the image managing execution part 400 accumulated the bibliographic information, “THUMB-NAIL ID” for specifying a thumb-nail, and a like. “NUMBER OF COPIES”, “FINISHER INFORMATION”, and “IMAGE PROCESS INFORMATION” are retrieved from the copy specific information of the MCS 1225. “DOCUMENT ID” shows a pointer showing a location where the image data managed by the MCS 1225 is stored. Similarly, “THUMB-NAIL ID” shows a pointer sowing a location where the thumb-nail managed by the MCS 1225 is stored. The bibliographic information managed by the image managing execution part 400 is referred to provide the Web service through the network 15.

As described above, in a case of a copy, the bibliographic information is managed by the MCS 1225 and the image managing execution part 400.

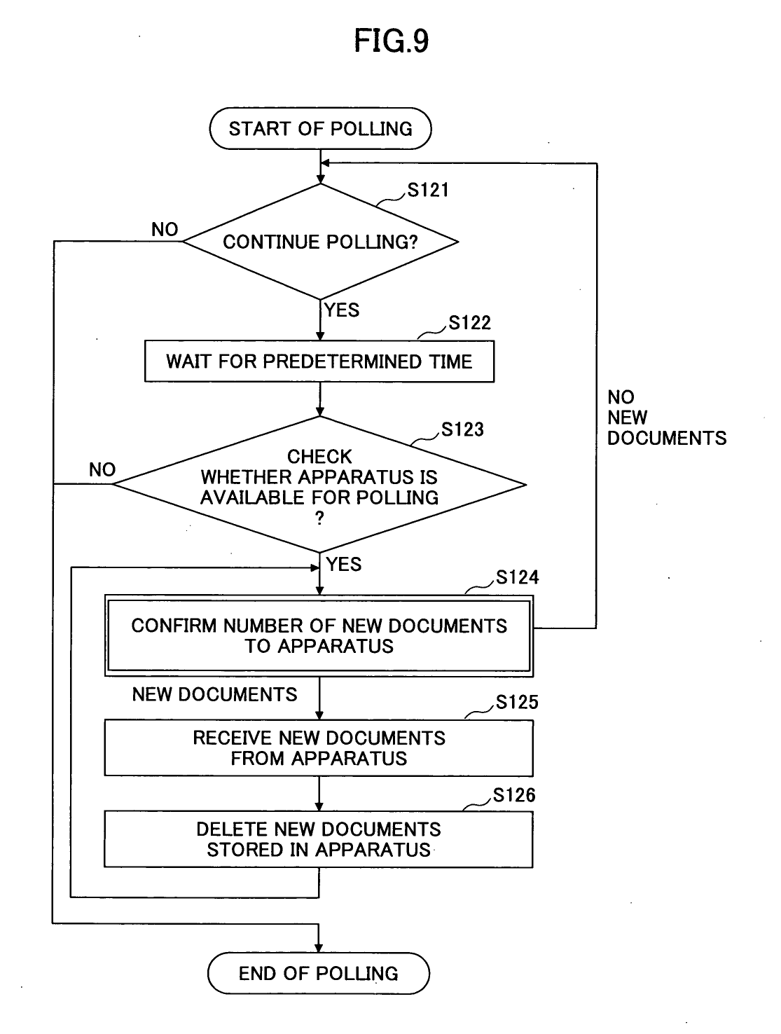

FIG. 9 is a flowchart for explaining a polling process conducted from the user PC to the multi-functional apparatus according to the embodiment of the present invention. In FIG. 9, the user PC 10 determines whether or not the polling is continued to the multi-functional apparatus 1200 (step S121). When it is determined that the polling is not continued, the polling process is terminated. On the other hand, when it is determined that the polling is continued, the polling process waits for a predetermined time to resume (step S122).

When the predetermined time passes, the polling process checks whether or not multi-functional apparatus 1200 is in a state capable of processing the polling (step S123). That is, the user PC 10 sends the HTTP request to the system information obtaining execution part 400 of the multi-functional apparatus 1200. The user PC 10 determines whether or not the multi-functional apparatus 1200 is in the state capable of capable of processing the polling. When it is determined that the multi-functional apparatus 1200 is not in the state capable of processing the polling, the polling process is terminated.

On the other hand, when it is determined that the multi-functional apparatus 1200 is in the state capable of processing the polling, the polling process of the user PC 10 confirms the number of new received documents to the multi-functional apparatus 1200 (step S124). That is, the user PC 10 sends the HTTP request with respect to the image managing execution part 400 of the multi-functional apparatus 1200. The user PC 10 obtains the number of the new received documents by the HTTP response from the multi-functional apparatus 1200. When the HTTP response does not show that there is no new received document, the polling process goes back to the step S121.

On the other hand, when the HTTP response shows that there are new received documents, the user PC 10 receives the new received documents from the multi-functional apparatus 1200 (step S125). That is, the user PC 10 sends the HTTP request for requesting new received documents with respect to the image managing execution part 400 of the multi-functional apparatus 1200, and receives the new received documents by the HTTP response sent from the multi-functional apparatus 1200. The user PC 10 requests to delete the new received document to the multi-functional apparatus 1200 (step S126). That is, the user PC 10 sends the HTTP request for deleting the new received documents with respect to the image managing execution part 400 of the multi-functional apparatus 1200, and receives the HTTP response showing a delete completion from the multi-functional apparatus 1200.

In the flowchart shown in FIG. 9, the new received documents are deleted. Alternatively, instead of deleting the new received documents, the new received documents can be maintained by the image managing execution part 400 of the multi-functional apparatus 1200.

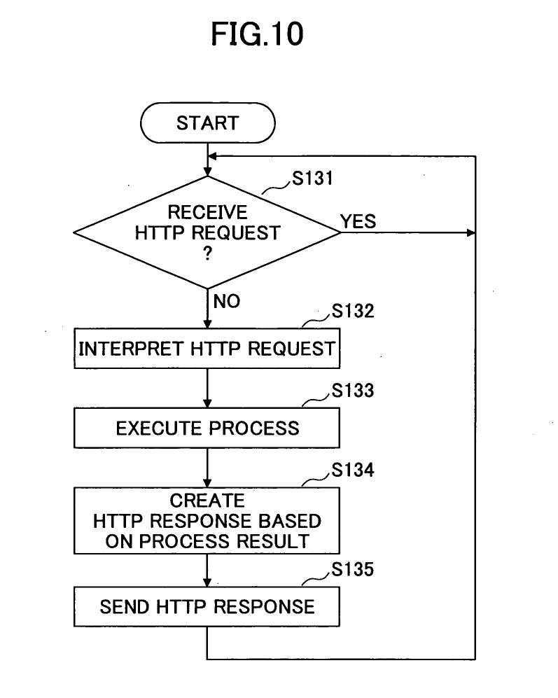

FIG. 10 is a flowchart for briefly explaining a Web service providing process conducted by the multi-functional apparatus according to the embodiment of the present invention. In FIG. 10, the multi-functional apparatus 1200 determines whether or not the HTTP request is received from the user PCs 10 and other devices (other than the user PCs 10) (step S131). When no HTTP request is received, the Web service providing process goes back to the step S131 to wait for the HTTP request. On the other hand, when the HTTP request is received, the Web service providing process interprets a message included in the HTTP request (step S132).

A process corresponding to the message included in the HTTP request is executed (step S133). The multi-functional apparatus 1200 creates the HTTP response based on the process result obtained by executing the process (step S134). Then, the multi-functional apparatus 1200 sends the HTTP response created corresponding to the HTTP request to a sender of the HTTP request.

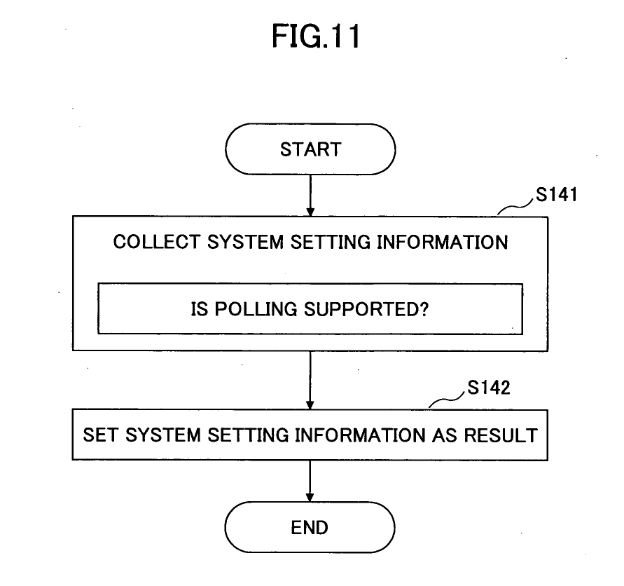

In the step S123 in FIG. 9, a process, which is conducted by the multi-functional apparatus 1200 when the multi-functional apparatus 1200 receives the HTTP request for requesting the system information which the user PC 10 sends to the system information obtaining execution part 401 of the multi-functional apparatus 1200, will be described with reference to FIG. 11.

FIG. 11 is a flowchart for explaining the system information providing process conducted by the multi-functional apparatus according to the embodiment of the present invention. In FIG. 11, in the multi-functional apparatus 1200, the system information obtaining execution part 401 collects system setting information from the SCS 1222 (step S141). In this case, the system information obtaining execution part 401 obtains information showing a presence or absence of support of the polling by the multi-functional apparatus 1200 from the SCS 1222. Then, the multi-functional apparatus 1200 sets the system setting information including the presence or absence of support of the polling to the HTTP response and sends the HTTP response to the user PC 10 (step S142), and the system information providing process is terminated.

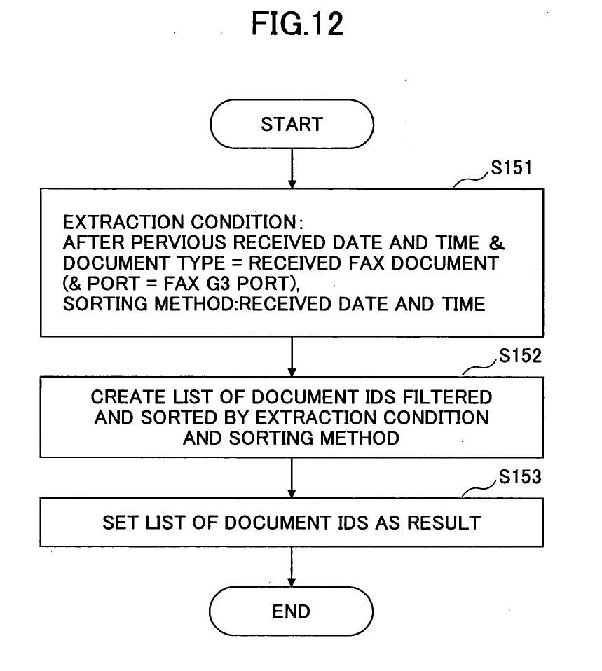

In the step S123 in FIG. 9, when the user PC 10 confirms the number of the new received documents to the multi-functional apparatus 1200, the user PC 10 sets a condition to the HTTP request. Setting the condition will be described with reference to FIG. 12 through FIG. 14. FIG. 12 is a flowchart for explaining a first process for a case in that a sorting method is the received date and time, according to the embodiment of the present invention. In FIG. 12, the multi-functional apparatus 1200 extracts the condition from the HTTP request (step S151). For example, as an extraction condition, the HTTP request indicates “AFTER PREVIOUS RECEIVED DATE AND TIME” and that a document type is “RECEIVED FAX DOCUMENT”, and “RECEIVED DATE AND TIME” as the sorting method. Furthermore, “G3 PORT” of fax may be indicated as a subject port.

The image managing execution part 400 of the multi-functional apparatus 1200 creates a list of documents IDs which are filtered and sorted by the extraction condition and the sorting method (step S152). The list of document IDs are set in the HTTP response as a result (step S153).

In this case of the first process, the user PC 10 is not required to maintain all information concerning the image data received from the multi-functional apparatus 1200. “RECEIVED DATE AND TIME” is preferably sorted by msec in a case of considering that the plurality of ports may receive the image data simultaneously.

Also, the user PC 10 can receive the image data for each port (for each path of inputting the image data) Therefore, it is possible for the user PC 10 to receive the image data by narrowing necessary information. The plurality ports are the NIC 1311, the USB target 1312, the IEEE1394 1313, the centronics 1314, the serial port 1315, the USB host 1316, and the FCU 1320 (each of G3, G3 option, G4 option) shown in FIG. 4. Since the user PC 10 can receive the image data for each of image forming means, the user PC 10 can receive the image data by narrowing necessary information. The image forming means are the FCU 1320 (each of G3, G3 option, G4 option), the plotter 1201, the scanner 1202, the other hardware resources 1203.

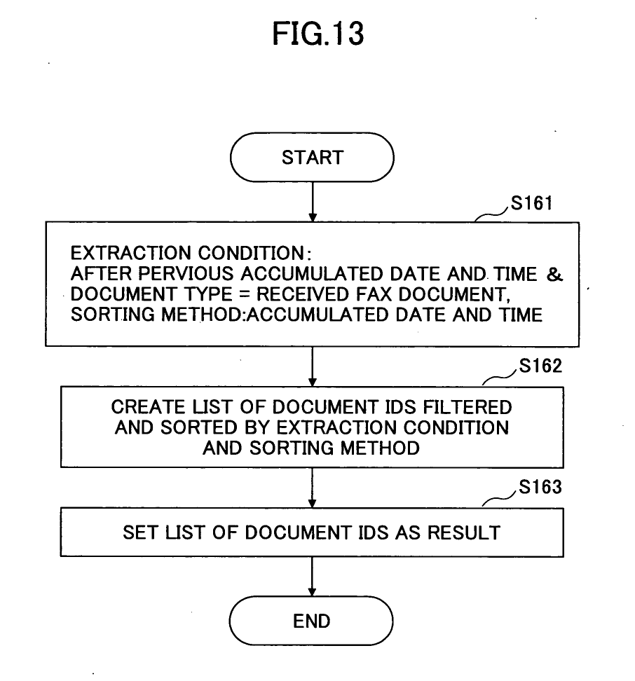

FIG. 13 is a flowchart for explaining a second process for a case in that the sorting method is the accumulated date and time, according to the embodiment of the present invention. In FIG. 13, the multi-functional apparatus 1200 extracts an extraction condition from the HTTP request (step S161). For example, as the extraction condition, the HTTP request indicates “PREVIOUS ACCUMULATED DATE AND TIME” and that the document type is “RECEIVED FAX DOCUMENT”, as an extraction condition. And as the sorting method, the HTTP request indicates “ACCUMULATED DATE AND TIME”.

The image managing execution part 400 of the multi-functional apparatus 1200 creates a list of documents IDs which are filtered and sorted by the extraction condition and the sorting method (step S162). The list of document IDs are set in the HTTP response as a result (step S163).

In this case of the second process, the image data is centralized and managed in the HDD 1303 by the MSC 1225 and the accumulated date and time is determined by using the RTC 1323 of the SB 1307 of the controller 1300. Therefore, it is possible to manage by msec unit different from the RTC 1322 of the FCU 1320 managing by minute unit. Accordingly, even if various image data are simultaneously received, received time differences among the various image data can be clocked properly. Thus, it is possible to properly sort the image data by date and time after the accumulated date and time which are indicated by the sorting method. Moreover, it is possible to receive the image data by a final updated date and time by msec unit without redundantly receiving the same image data.

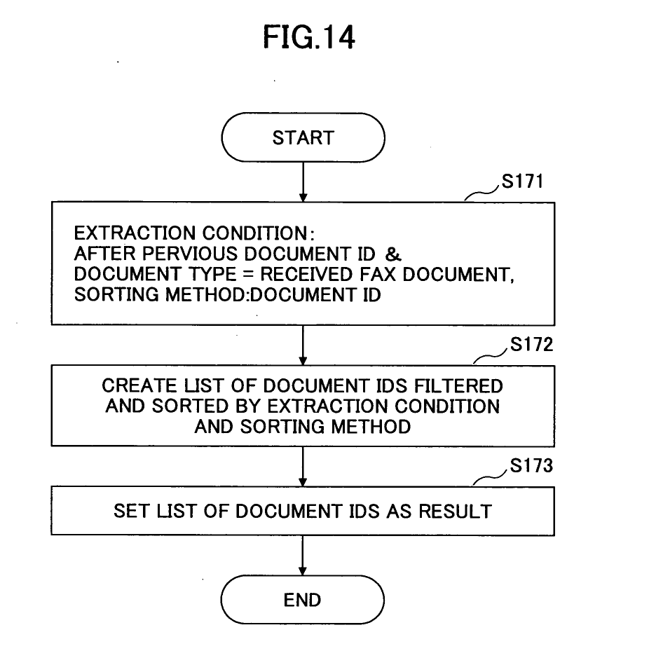

FIG. 14 is a flowchart for explaining a third process for a case in that the sorting method is the document ID, according to the embodiment of the present invention. In FIG. 14, the multi-functional apparatus 1200 extracts an extraction condition from the HTTP request (step S161). For example, as the extraction condition, the HTTP request indicates “AFTER PREVIOUS DOCUMENT ID” and that the document type is “RECEIVED FAX DOCUMENT”. And as the sorting method, the HTTP request indicates “DOCUMENT ID”.

The image managing execution part 400 of the multi-functional apparatus 1200 creates a list of documents IDs which are filtered and sorted by the extraction condition and the sorting method (step S172). The list of document IDs are set in the HTTP response as a result (step S173).

In this case of the third process, since it is not required to conduct a time management by msec unit, it is possible to reduce a memory area by area for the time management. Moreover, since the document ID, which simply increase in chronological order, the document ID always shows identical even if the RTC 1323 of the multi-functional apparatus 1200 is reset for any reason. Since the document ID is simply increased, the image data can be identified by the document ID even if time is set backward. In this case, the document ID is managed in a non-volatile memory.

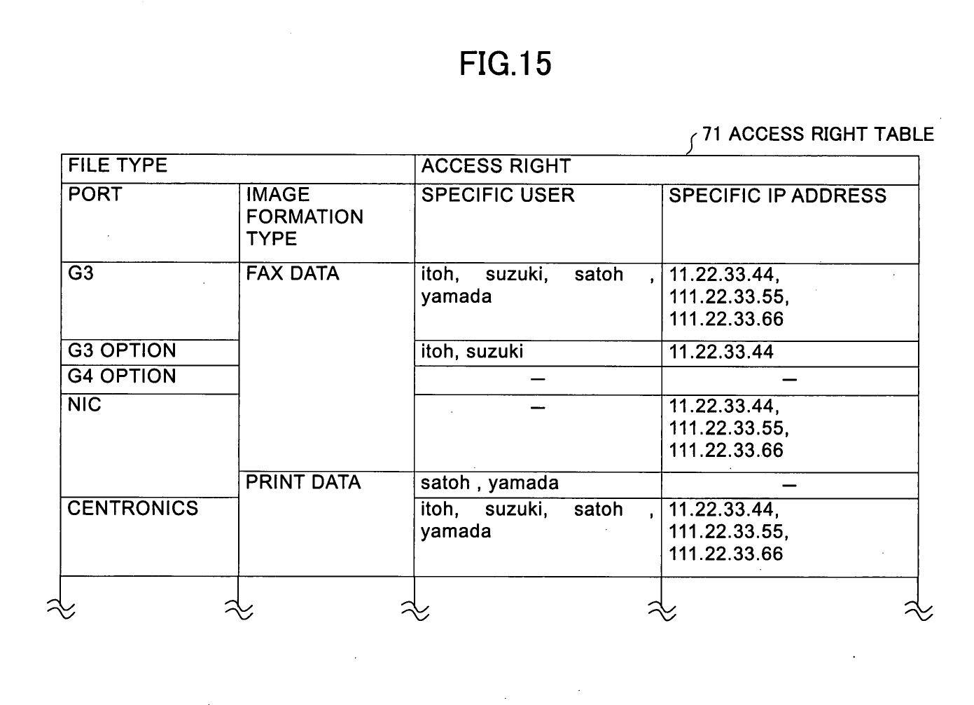

A document writing out process and a document deleting process, in that the user PC 10 writes out and deletes the document accumulated in the multi-functional apparatus 1200 based on an access right set for each of the plurality of ports, will be described with reference to FIG. 15 through FIG. 17.

FIG. 15 is a diagram showing an access right table showing an access right set for each port, according to the embodiment of the present invention. The access right table 71 shown in FIG. 15 includes items of “FILE TYPE” shown by “PORT” and “IMAGE FORMATION TYPE”, “SPECIFIC USER” showing user name allowed to access a document accumulated in the multi-functional apparatus 1200, “SPECIFIC IP ADDRESS” showing an IP address of the user PC 10, and an access right. “SPECIFIC USER” may show the user name, or user group name showing a group formed by the plurality of users.

“PORT” of “FILE TYPE” shows the NIC 1311, the USB target 1312, the IEEE1394 1313, the centronics 1314, the serial port 1315, the USB host 1316, or the FCU 1320 (each of G3, G3 option, G4 option) shown in FIG. 4. “IMAGE FORMATION TYPE” of “FILE TYPE” shows a type of the engine part 1350 of the FCU 1320, the plotter 1201, the scanner 1202, and the like, or information specifying each of applications conducting the image formation by utilizing the engine part 1350.

“SPECIFIC USER” of “ACCESS RIGHT” shows that the users listed are allowed to access. “SPECIFIC IP ADDRESS” of “ACCESS RIGHT” shows that accesses from IP addresses listed are allowed. When a combination of “SPECIFIC USER” and “SPECIFIC IP ADDRESS” is satisfied. That is, only when the user allowed to access accesses from the user PCs 10 having the IP addresses listed in “SPECIFIC IP ADDRESS”, the user can access the document accumulated in the multi-functional apparatus 1200.

In the access right table 71 shown in FIG. 15, as FAX data, with respect to the document sent or received through the standard port G3 of the FCU 1320 shown in FIG. 4 and accumulated in the multi-functional apparatus 1200, the access right is given when the user is “itoh”, “Suzuki”, “satoh”, or “yamada” and the IP address of the user PC 10 is “11.22.33.44”, “111.22.33.55”, or “111.22.33.55”.

Moreover, as the FAX data, with respect to the document sent or received through the port G3 option of the FCU 1320 shown in FIG. 4 and accumulated in the multi-functional apparatus 1200, the access right is given when the user is “itoh” or “Suzuki” and the IP address of the user PC 10 is “11.22.33.44”.

Furthermore, as the FAX data, with respect to the document sent or received through the port G4 option of the FCU 1320 shown in FIG. 4 and accumulated in the multi-functional apparatus 1200, the user is not specified to allow (when “SPECIFIC USER” shows “-” in the access right table 71 in FIG. 15, no user is listed) and the IP address is not specified (when “SPECIFIC IP ADDRESS” shows “-” in the access right table 71 in FIG. 15, no IP address is listed) That is, any user can access the documents accumulated in the multi-functional apparatus 1200 from any user PC 10.

Moreover, as the FAX data, with respect to the document sent or received through the NIC 1311 of the FCU 1320 shown in FIG. 4 and accumulated in the multi-functional apparatus 1200, the user is not specified and the access right is given when the IP address of the user PC 10 is “11.22.33.44”, “111.22.33.55”, or “111.22.33.66”.

Similarly, as print data, with respect to the document sent or received through the NIC 1311 or the centronics shown in FIG. 4, the access right is limited to the user name and the IP address listed in the access right table 71.

In the access right table 71 in FIG. 15, the file types are categorized by the port and the image formation type. Alternatively, the file types may be categorized by the port alone or the image formation type alone. In a case of setting an access right, a detailed access right can be set for each of access types.

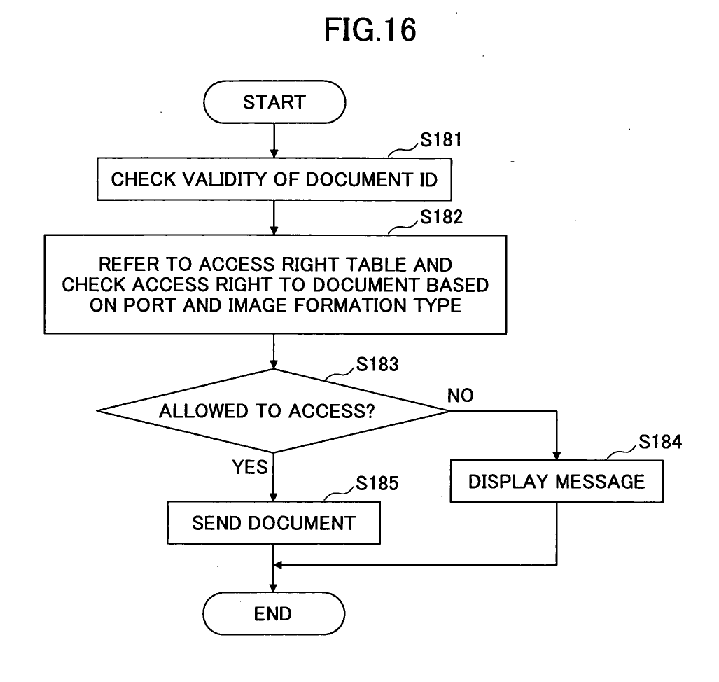

The document writing out process, which is conducted based on the access right table 71 as shown in FIG. 15 when the HTTP request for requesting to write out the document is received from the user PC 10, will be described with reference to FIG. 16. FIG. 16 is a flowchart for explaining the document writing out process conducted by the multi-functional apparatus 1200 according to the embodiment of the present invention.

In FIG. 16, the image managing execution part 400 of the multi-functional apparatus 1200 checks a validity of the document ID requested in the HTTP request (step S181). After the validity is checked, the access right table 71 is referred to, and the access right to the document is checked based on the port and the image formation type (step S182) It is determined whether or not a check result shows that the access is allowed (step S183). When the access is allowed, the multi-functional apparatus 1200 writes out the document to the HTTP response and the document is provided to the user PC 10 by the HTTP response (step S185). Then, the document writing out process is terminated. On the other hand, when the access is denied, the multi-functional apparatus 1200 cancels to write out the document to the HTTP response and sends a message showing that the user PC 10 does not have the access right, to display at the user PC 10 (step S184). Then, the document writing out process is terminated.

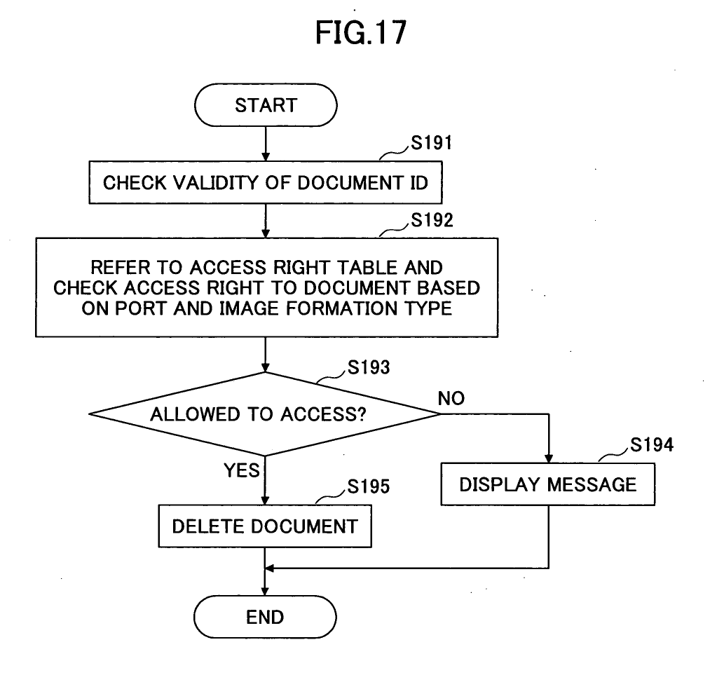

The document deleting process, which is conducted by the multi-functional apparatus 1200 based on the access right table 71 as shown in FIG. 15 when the HTTP request for requesting to delete the document is received from the user PC 10, will be described with reference to FIG. 17. FIG. 17 is a flowchart for explaining the document deleting process conducted by the multi-functional apparatus according to the embodiment of the present invention. In FIG. 17, the image managing execution part 400 of the multi-functional apparatus 1200 checks a validity of the document ID requested in the HTTP request (step S191). After the validity is checked, the access right table 71 as shown in FIG. 15 is referred to, and the access right to the document is checked based on the port and the image formation type (step S192). It is determined whether or not a check result shows that the access is allowed (step S193). When the access is allowed, the multi-functional apparatus 1200 deletes the document and this process result is provided to the user PC 10 by the HTTP response (step S195). Then, the document deleting process is terminated. On the other hand, when the access is denied, the multi-functional apparatus 1200 cancels to delete the document to the HTTP response and sends a message showing that the user PC 10 does not have the access right, to display at the user PC 10 (step S194). Then, the document deleting process is terminated.

Similarly, this document deleting process can be conducted in a case in that the user instructs at the operation panel 1310 of the multi-functional apparatus 1200. When the user does not have the access right, the message is displayed at the operation panel 1310.

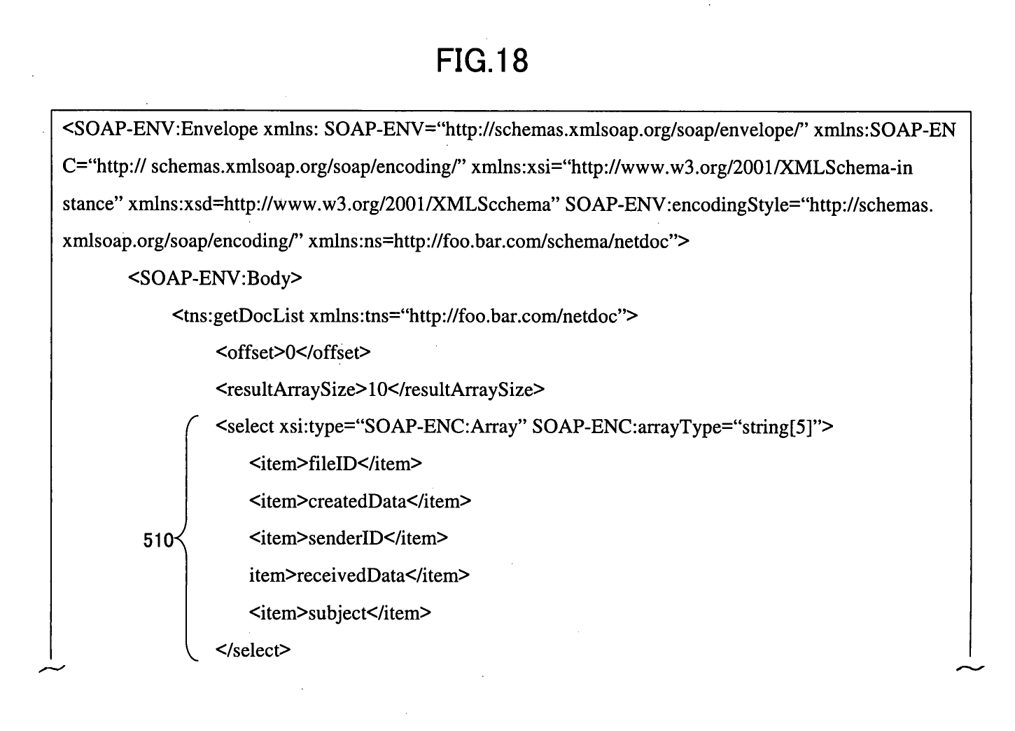

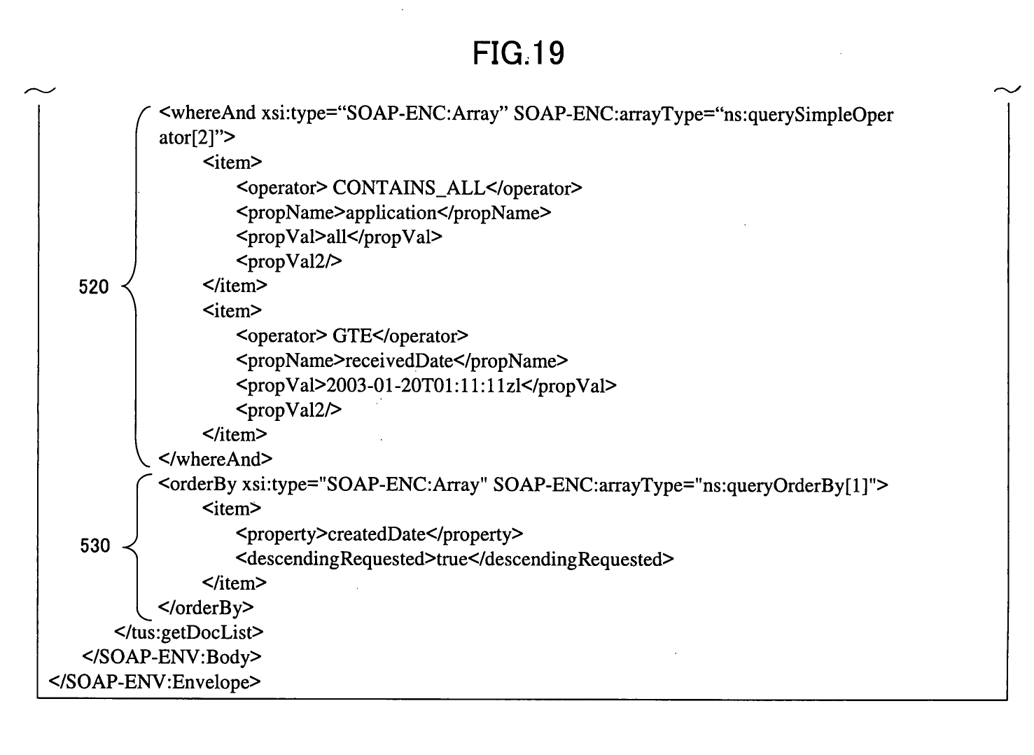

Next, the HTTP request indicating the extraction condition and the sorting method sent from the user PC 10 will be described with reference to FIG. 18 and FIG. 19. FIG. 18 and FIG. 19 are diagrams showing the HTTP request indicating the extraction condition and the sorting method sent from the user PC, according to the embodiment of the present invention.

In FIG. 18, items to extract are indicated by a description 510 (<select>tag) written in a SOAP body. For example, five items are indicated by a <item>tag, that is, “fileID”, “createdData”, “senderID”, “receivedData”, and “subject” are indicated. The extraction condition is indicated by a description 520 (<whereAnd>tag). Especially, by descriptions “<propName>receivedDate</propName>” and “<propVal>2003-01-20T01:11:11zl</propVal>”, a received date and time is after “1 min 11 sec 1 msec on Jan. 20th, 2003” as the extraction condition.

And the sorting method is indicated by a description 530 (<orderBy>tag). For example, by descriptions “<property>createdDate</property>” and “<descendingRequested>true</descendingRequested>”, to sort by a descending order of the created date is indicated as the sorting method.

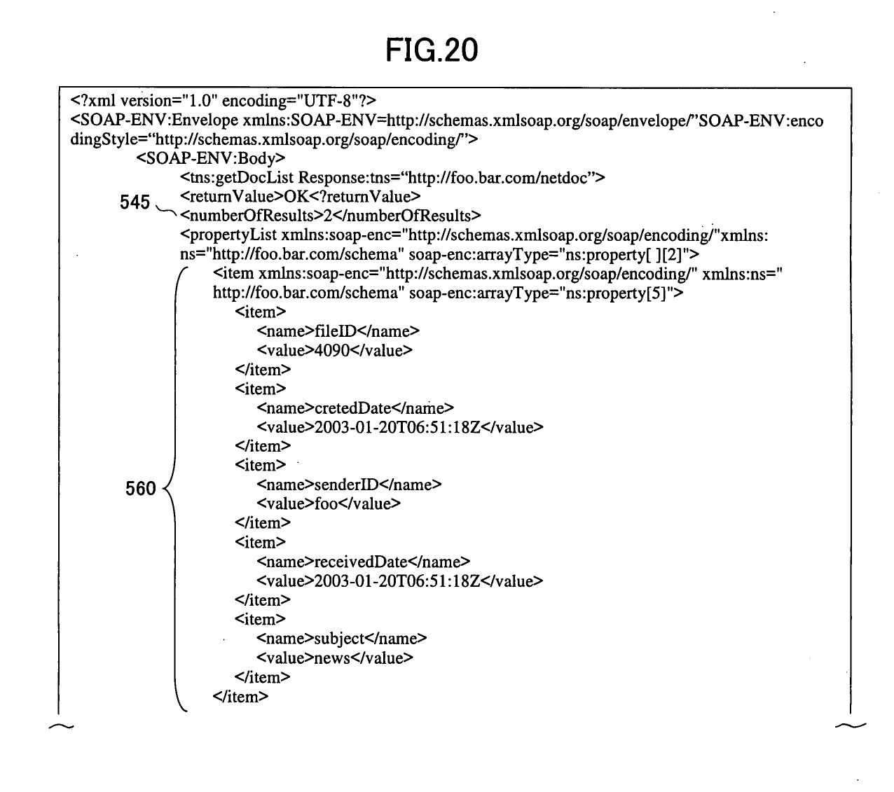

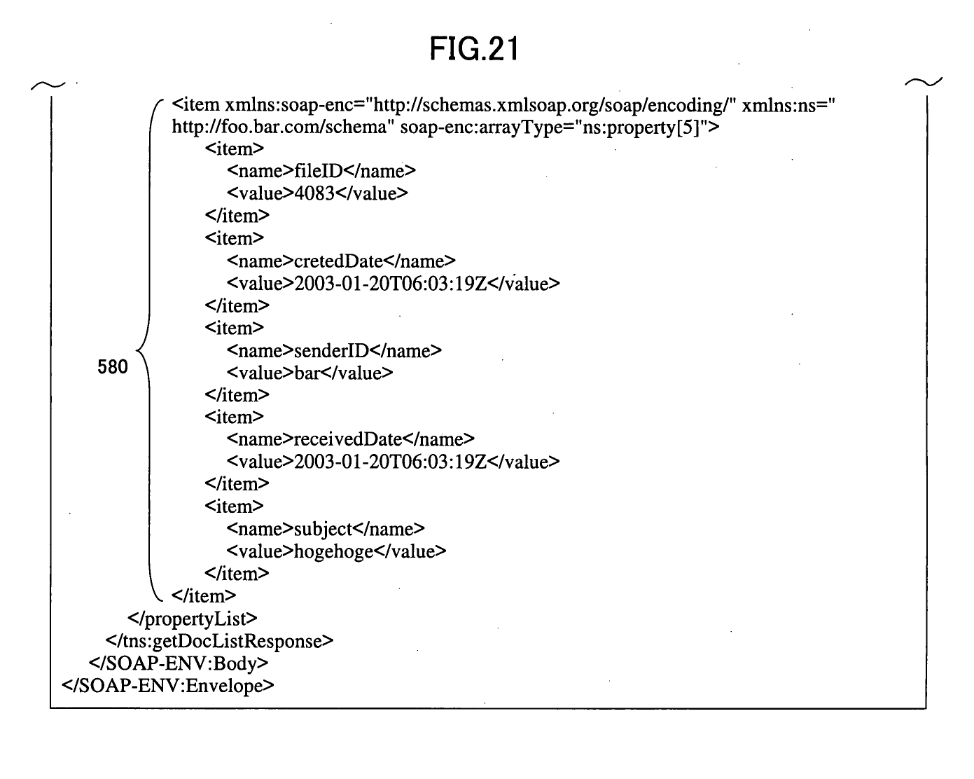

The image managing execution part 400 of the multi-functional apparatus 1200 conducts a process corresponding to the HTTP request shown in FIG. 18 and FIG. 19. and sends the process result by the HTTP response. FIG. 20 and FIG. 21 are diagrams showing the HTTP response showing a sort result sent by the multi-functional apparatus according to the embodiment of the present invention.

In FIG. 20 and FIG. 21, a description 545 (<numberOfResults>2</numberOfResults>) shows that two documents satisfy the extraction condition. A description 560 shows the bibliographic information of a first document. The bibliographic information shows values indicated by the description 510 of the HTTP request shown in FIG. 18. For example, a value of the item “fileID” is “4090”, a value of the item “cretedDate” is “2003-01-20T06:51:18Z”, a value of the item “senderID” is “foo”, a value of the item “receivedDate” is “2003-01-20T06:51:18Z”, and a value of the item “subject” is “news”.

A description 580 shows the bibliographic information of a second document. For example, a value of the item “fileID” is “4083”, a value of the item “cretedDate” is “2003-01-20T06:03:19Z”, a value of the item “senderID” is “bar”, a value of the item “receivedDate” is “2003-01-20T06:03:19Z”, and a value of the item “subject” is “hogehoge”.

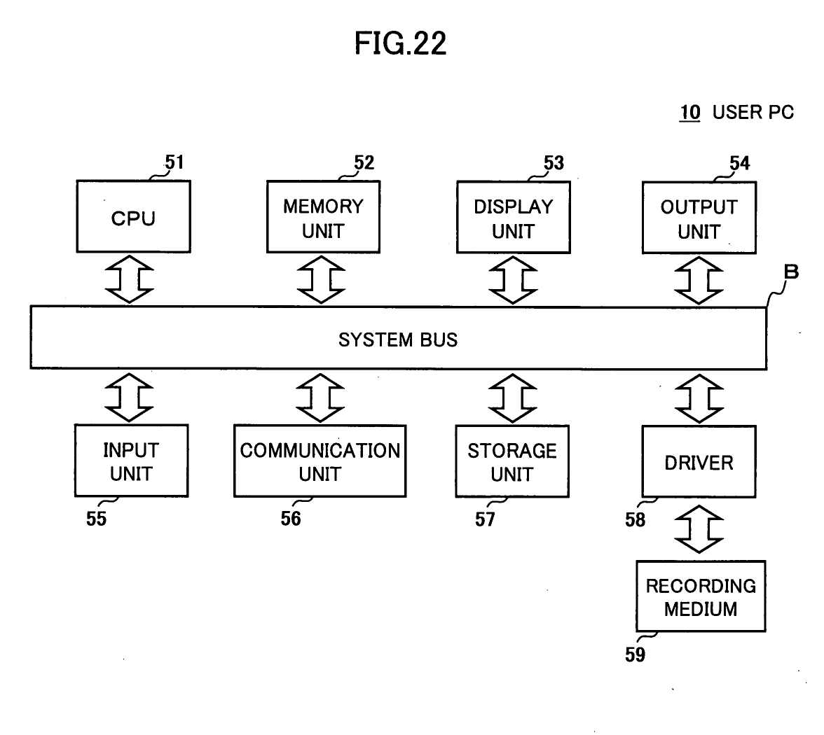

For example, the user PC 10 in this embodiment includes a hardware configuration as shown in FIG. 22. FIG. 22 is a block diagram showing the hardware configuration of the user PC according to the embodiment of the present invention.

In FIG. 22, the user PC 10 is a terminal controlled by a computer, and includes a CPU (Central Processing Unit) 51, a memory unit 52, a display unit 53, an output unit 54, an input unit 55, a communication unit 56, a storage unit 57, and a driver 58, which are mutually connected via a system bus B.

The CPU 51 controls the user PC 10 in accordance with programs stored in the memory unit 52. The memory unit 52 includes a RAM (Random Access Memory), a ROM (Read-Only Memory), and a like, and stores the programs executed by the CPU 51, data necessary for processes in the CPU 51, data obtained while the CPU 51 conducts the processes, and a like. The memory unit 52 is partially used to assign as a working area for the CPU 51 to conduct the process.

The display unit 53 is used to display various information necessary under a control by the CPU 51. The output unit 54 includes a printer, and is sued to output various information in response to an instruction from the user. The input unit 55 includes a mouse, a keyboard, or a like, and is used to input various information necessary for the user PC 10 to conduct a process. The communication unit 56 is a device for controlling a communication with the multi-functional apparatus 1200 when the user PC 10 is connected to the multi-functional apparatus 1200 through the Internet, a LAN (Local Area Network), or a like. The storage unit 57 includes a hard disk unit, and stores the programs executing various processes, data such as document received from the multi-functional apparatus 1200, and a like.

For example, the program realizing the process conducted by the user PC 10 is installed to the user PC 10 by a recording medium 59 such as a CD-ROM (Compact Disc Read-Only Memory). That is, when the recording medium 59 storing the program is set in the driver 58, the driver 58 reads the program from the recording medium 59 and the program read from the recording medium 59 is installed in the storage unit 57 via the system bus B. When the program is executed, the CPU 51 starts the process in accordance with the program installed to the storage unit 57. It should be noted that the recording medium storing the program is not limited to the CD-ROM but various computer-readable recording media can be used. The program for realizing the process according to the present invention may be downloaded by the communication unit 56 through the network, and installed to the storage unit 57.

As described above, in the present invention, instead of providing the receiving/distributing server in the network 15, by polling a state of the multi-functional apparatus 1200 from the user PC 10, for example, after the document is received by fax, the user PC 10 can automatically receives the document from the multi-functional apparatus 1200 without the special server such as the receiving/distributing server. In this case, it is determined whether or not there are the new received documents, and the user PC 10 can receive the documents from the multi-functional apparatus 1200 without skipping any documents.

According to the present invention, the image data received from the plurality of the ports and generated by the plurality of the image forming means are centralized and accumulated in the HDD 1303. In a case of obtaining the documents to edit or to save as a backup, the user PC 10 can define a timing of obtaining the documents. Therefore, it is possible to reduce a transmitted data amount in the network.

Moreover, the multi-functional apparatus 1200 according to the present invention centralizes and manages the image data sent or received through the plurality of ports: the SB 1307, the NIC 1311, the USB target 1312, the IEEE1394 1313, the centronics 1314, the serial port 1315, the USB host 1316, and the FCU 1320 (each of G3, G3 option, G4 option), in the HDD 1303. Therefore, the user PC 10 can obtain the image data which the multi-functional apparatus 1200 externally received through various communication protocols, by simply indicating one of the ports. The user PC 10 is not required to manage the plurality of ports. Similarly, the user PC 10 can have the same effect in a case of the plurality of the image formation means: the plotter 1201, the scanner 1202, the other hardware resources 1203, or the like.

According to the present invention, without installing the receiving/distributing server other than the image forming apparatus through the network, in response to the polling for inquiring a state of the image forming apparatus from a user terminal, the image forming apparatus can provide the document (image data) indicated by the polling to the user terminal. Moreover, since the image forming apparatus centralizes and manages the image data received from the plurality of ports, it is not required to mount various communication parts. Furthermore, the user terminal can receive the image data desired by the user from various image data centralized in the image forming apparatus.

Moreover, an information processing apparatus such as the multi-functional apparatus 1200 according to the present invention can be realized by installing or downloading a computer-executable program for causing a computer functioning as an information processing apparatus to obtain a data file from a server computer capable of accumulating the data file through a network, the program including the codes for: (a) obtaining a number of new data files newly accumulated in an image forming apparatus capable of accumulating data files, through a network; and (b) receiving part sending a request of transmitting an entire or a part of the new data files to the image forming apparatus based on the number of new data files obtained from the image forming apparatus by said code (a).

The present invention is not limited to the specifically disclosed embodiments, and variations and modifications may be made without departing from the scope of the present invention.

The present application is based on the Japanese Priority Applications No.2003-063976 filed on Mar. 10, 2003 and No. 2004-55693 filed on Mar. 1, 2004, the entire contents of which are hereby incorporated by reference.

What is claimed is:

1. An image forming apparatus, comprising:
a plurality of communication ports sending and receiving data in accordance with different communication protocols;
a data managing part storing and managing the data received from the plurality of communication ports as a data file in a storing part;
a data distributing part distributing the data file to a device in response to a request concerning obtaining the data file from the device connected to said image apparatus through a network.

2. The image forming apparatus as claimed in claim 1, further comprising a plurality of image processing parts conducting different image processes for data in accordance to different process types.

3. The image forming apparatus as claimed in claim 1, wherein said data distributing part includes a file providing part providing the data file corresponding to file identification information indicated by an obtain request when the obtain request of the data file is received from the device.

4. The image forming apparatus as claimed in claim 3, wherein said data distributing part further includes an extraction result providing part conducting a process in accordance with the communication port or the process type indicated by an extraction condition included in an extract request, and providing an extraction result to the device, when the extract request of the data file is received from the device.

5. The image forming apparatus as claimed in claim 4, wherein said extraction result providing part extracts data related information concerning data of the data file from the storing part in accordance with the extraction condition.

6. The image forming apparatus as claimed in claim 3, wherein said file providing part includes:
a first part checking a validity of the file identification information;
a second part checking an access right to the data file identified by the file identification information; and
a third part accessing the data file identified by the file identification information based on a check result by said second part.

7. The image forming apparatus as claimed in claim 1, further comprising a communication controlling part conducting a communication control in accordance with a predetermined Web communication protocol,
wherein said data distributing part includes a description form processing part interpreting contents of the request in accordance with a predetermined description form and creating a process result corresponding the request in accordance with the predetermined description form.

8. The image forming apparatus as claimed in claim 7, wherein said data distributing part includes a message exchange processing part processing the request received by said communication controlling part in accordance with a predetermined message exchanging protocol, so that the request is informed to said description form processing part, and creating a response based on the process result, which is created by said description form processing part, in accordance with the message exchange protocol, so that the response is sent to the device by the communication controlling part.

9. A data distributing method for externally receiving data and distributing the data to a device through a network, comprising the steps of:
sending and receiving the data in accordance with a plurality of different protocols;
storing and managing the data received in accordance with the plurality of different protocols as a data file in a predetermined storage area;
sending a request concerning obtaining the data file from the device through the network; and
distributing the data file to the device in response to the request.

10. A data distributing method for externally receiving data and distributing the data to a device through a network, comprising the steps of:
conducting image processes to the data corresponding to different process types;
storing and managing the data as the data file in a predetermined storage area; and
distributing the data file to the device in response to a request concerning obtaining the data file from the device through the network.

11. An information processing apparatus, comprising:
a number-of-new-files obtaining part obtaining a number of new data files newly accumulated in an image forming apparatus capable of accumulating data files, through a network;
receiving part sending a request of transmitting an entire or a part of the new data files to the image forming apparatus based on the number of new data files obtained from the image forming apparatus by said number-of-new-files obtaining part.

12. The information processing apparatus as claimed in claim 11, further comprising a delete requesting part sending a request of deleting the new data files received by said receiving part to the image forming apparatus.

13. The information processing apparatus as claimed in claim 12, wherein said number-of-new-files obtaining part is executed with respect to the image forming apparatus at predetermined time intervals.

14. The information processing apparatus as claimed in claim 11, further comprising a communication controlling part controlling a communication with the image forming apparatus in accordance with a predetermined Web protocol.

15. A computer-readable recording medium recorded with a program for causing a computer functioning as an information processing apparatus to obtain a data file from a server computer capable of accumulating the data file through a network, said program comprising the codes for:
(a) obtaining a number of new data files newly accumulated in an image forming apparatus capable of accumulating data files, through a network; and
(b) receiving part sending a request of transmitting an entire or a part of the new data files to the image forming apparatus based on the number of new data files obtained from the image forming apparatus by said code (a).

16. An image forming apparatus, comprising:
a plurality of image processing parts conducting different image processes for data in accordance to different process types;
a data managing part storing and managing the data received from the plurality of communication ports as a data file in a storing part;
a data distributing part distributing the data file to a device in response to a request concerning obtaining the data file from the device connected to said image apparatus through a network.
